(19) United States
(12) Patent Application Publication
(10) Pub. No.: US 2012/0061454 A1
(43) Pub. Date: Mar. 15, 2012

(54) EXOTHERMIC MIXTURE

(75) Inventors: Wayne Rudd, Newcastle Upon Tyne (GB); Allison Rudd, Newcastle Upon Tyne (GB); Diane Hopper, Houghton Le Spring (GB); Hu Chun Yi, Lakewood, CO (US)

(73) Assignee: TUBEFUSE APPLICATIONS B.V., Zuid-Holland (NL)

(21) Appl. No.: 13/125,632

(22) PCT Filed: Oct. 23, 2009
(86) PCT No.: PCT/GB2009/002541

§ 371 Date: Nov. 9, 2011

(30) Foreign Application Priority Data
Oct. 23, 2008 (GB) 0819428.4

(51) Int. Cl. B23K 20/00; B23K 37/00; B23K 20/26; C09K 3/00

(52) U.S. Cl. 228/198; 252/183.14; 228/33

(57) ABSTRACT

An exothermic reaction mixture for joining metallic components includes at least one transition metal oxide and, as fuel, a mixture of aluminium and calcium suicide, wherein the molar ratio of aluminium to calcium suicide is from 16:1 to 0.25:1. Methods of preparing the exothermic reaction mixtures and for using them in welding applications are also described.

### FIELD OF THE INVENTION

The present invention relates to the provision of improved exothermic reaction mixtures for use in welding or joining metallic structures in a wide range of applications.

### BACKGROUND OF THE INVENTION

Techniques for joining together metallic components using exothermic reaction mixtures are known. Typical reaction mixtures comprise aluminium as fuel and a metal oxide, such as copper oxide. On ignition the mixture reacts exothermically to generate the liquid metal and an aluminium oxide slag. The generated hot liquid metal, termed as superheated liquid metal (SLM) in the current document, can be used as welding material to join metallic components together. The liquid metal both heats the two components to be joined and bridges between the components to form a welded joint. By this means satisfactory joins can be formed between various metals, such as for example, copper, iron and alloys of these metals with other metals. These exothermic mixtures thus provide an alternative to other joining techniques such as by melting metallic compositions by oxy-acetylene torch or electric arc. The exothermic reaction process is sometimes referred as the Combustion Synthesis reaction process.

In the known art exothermic welding compositions such as used for the Thermit® and Cadweld® Processes, aluminium is used as the fuel either solely or predominantly. These compositions make use of aluminium as fuel, and can contain small amounts of calcium silicide and/or calcium fluoride (<5% as specified in the Material Safety Data Sheet by Erico). Therefore, the slag formed in the prior arts has a chemical composition of predominately crystalline Al₂O₃. The known mixtures are successfully used for a number of metal joining applications but they can suffer from certain disadvantages. The mixtures can be difficult to ignite, requiring a high ignition temperature and high ignition energy. Once ignited the mixtures can have violent reaction characteristics leading to safety concerns in their use.

Furthermore the quality of the join depends on good separation of slag from the liquid metal. The liquid metals produced in prior art methods often contain Al₂O₃ inclusions leading to a weak joint.

A slag comprising largely Al₂O₃ has a high melting point and reduced ability to flow and can therefore be difficult to separate from the liquid metal during reaction leading to a poor quality joint.

### DESCRIPTION OF THE INVENTION

It is the object of the present invention to provide alternative and improved exothermic mixtures and methods for making them, which can be used for a wide range of metal joining processes.

Thus according to a first aspect the present invention provides an exothermic reaction mixture for use in joining metallic components comprising: at least one transition metal oxide; and, as fuel a mixture of aluminium and calcium silicide, wherein the molar ratio of aluminium to calcium silicide is from 16:1 to 0.25:1.

These mixtures of aluminium and calcium silicide are designed to produce ternary oxides of Al₂O₃—CaO—SiO₂, often in the form of an amorphous slag as opposed to the predominately crystalline Al₂O₃ slag produced in prior art reactions.

The predominately crystalline Al₂O₃ slag formed in the exothermic reaction of prior art mixtures has a high melting point and relatively high density. These characteristics hinder separation from the liquid metal leading to increased slag inclusions. The chemistry of the slag formed in the present invention is based on ternary oxides of Al₂O₃—CaO—SiO₂ which have lower melting temperatures and lower densities compared to crystalline Al₂O₃, thus producing improved slag flow and better slag-metal separation. In addition to the use of calcium silicide for the modification of the slag properties, calcium silicide is used in the current invention to modify reaction characteristics such as temperature of ignition and temperature of combustion.

Employment of calcium silicide in a thermite-type reaction is known. For example, a mixture of iron (II,III) oxide and calcium silicide (1:1 ratio) was used as a self-heating can during World War II (see J. B. Calvert, www.du.edu/˜jcalvert/phys/bang.htm). However, such mixtures are not suitable for welding metallic structures since the exothermic reaction temperature is too low. In the current invention, aluminium is used in combination with calcium silicide in at least in a 0.25:1 molar ratio but not exceeding an 16:1 molar ratio, to provide a reactant mixture that can generate a sufficiently high temperature for metal joining (welding) while still maintaining the improved slag flow and better slag-metal separation characteristics provided by the ternary oxide system. The improved mixture is particularly suitable for higher quality welding applications compared to prior art mixtures that only employ aluminium as fuel.

The exact composition of the slag, which is derived from the metal oxide and fuel compositions of the original exothermic reaction mixture can vary provided the temperature reached by the mixture following ignition is sufficient for the desired use and the slag produced has the required behaviour, i.e. it separates well from the molten metal under the reaction conditions. Compositions with aluminium to calcium silicide molar ratios from 16:1 to 0.25 to 1 are satisfactory for many applications.

The optimal ratio of aluminium to calcium silicide for the application is employed to achieve the desired melting of the metal component(s) of the mixture, which for good welding behaviour should be superheated, i.e. at a temperature sufficiently above melting point, to fuse properly with the metal components being joined. The theoretical temperature reached on reaction of a given mixture, the adiabatic temperature (T_{ad}), can be readily calculated, and experiment will show the actual temperature reached in a practical situation. Slag containing the ternary oxide mixtures often has amorphous (glassy) characteristics. The amorphous (glassy) nature of a slag can be confirmed by X-ray diffraction studies. Amorphous slag characteristics are favourable because the increased fluidity and lower density enhances the separation of the slag from the liquid metal, giving a purer metal phase which can provide a stronger join between metallic components.

More preferred compositions of the invention include those wherein the molar ratio of aluminium to calcium silicide in the mixture before combustion is from 10:1 to 0.4:1. Compositions with a molar ratio of 10:1 aluminium:calcium silicide, but at or above 0.4:1 have been found to produce satisfactory joins as described hereafter with reference to specific examples. In one particular reaction, compositions with a molar ratio of 10:1 aluminium:calcium silicide produce a slag composition corresponding to a 4:1 molar mixture of alumina (Al₂O₃):anorthite (CaAl₂Si₂O₈) which achieves good separation from the metal produced.

Most preferably the exothermic mixture has a molar ratio of aluminium to calcium silicide in the mixtures before reaction of 2:1. Such mixtures have an aluminium and calcium silicide content which generates a slag having the composition of the mineral anorthite (CaAl₂Si₂O₈). An anorthite slag has a composition of 20.2% CaO, 36.6% Al₂O₃, 43.2% SiO₂ (by % weight). Providing a mixture that produces an anorthite (CaAl₂Si₂O₈) slag on combustion has been found to be highly advantageous. Anorthite has a density of 2700 kgm⁻³ and a melting point of 1550° C. or 1823K. Both are substantially lower than that of the alumina (3960 kgm⁻³ and 2327 K respectively). These characteristics provide a slag that flows readily and separates quickly from the denser superheated liquid metals formed during reaction of the mixtures of the invention when compared to prior art mixtures which produce slags that are alumina or substantially alumina.

In addition, the formation reaction of the anorthite compound at T_{c} (Equation 1, discussed below) is itself an exothermic process, which increases the temperature of the overall reaction assisting in the fusing of the liquid metal(s) produced by the exothermic mixture, to the metallic components being joined during a welding process. In a typical embodiment of the invention, a glassy amorphous slag is formed during the reaction and quickly separates from and floats to the top of liquid metals thereby protecting them from oxidation if reaction was carried out in air.

In general, preferred compositions of the invention produce a slag with a composition in the following ranges (by weight):

### Calcium Oxide (CaO): 5.6-29.70;

### Silica (SiO₂): 12.1-63.6%;

### Alumina (Al₂O₃): 6.7-82.3%.

The exothermic mixture comprises at least one transition metal oxide. The transition metal oxides employed in the compositions of the invention may be any transition metal oxide. For example, but not limited to oxides of copper (Cu), iron (Fe), tin (Sn), nickel (Ni), chromium (Cr), cobalt (Co), vanadium (V), and molybdenum (Mo).

The exothermic reaction mixture may also comprise transition metals or other metals or alloys of transition metals and/or other metals. For example, transition metals that can be employed in the mixtures of the invention can include, but are not limited to copper (Cu), iron (Fe), tin (Sn), nickel (Ni), chromium (Cr), cobalt (Co), vanadium (V), manganese (Mn) and molybdenum (Mo).

The exothermic combustion synthesis reactions can be expressed as in Equation 1

$$α {M}_{x} {O}_{y} + 2 Al + β {CaSi}_{2} + {\sum }_{i} {x}_{i} {M}_{i} {\to }^{{T}_{ig}} {Al}_{2} {O}_{3} + β CaO + 2 β {SiO}_{2} + α x M + {\sum }_{i} {x}_{i} {M}_{i} {\to }^{{T}_{c}} {Ca}_{β} {Al}_{2} {Si}_{2 β} {O}_{3 + 5 β} + α x M + {\sum }_{i} {x}_{i} {M}_{i} \qquad ( 1 )$$

In Equation (1), M represent alloying metals (either elemental or alloyed metals), α, β, and xᵢ are numerical numbers and they are related by the relationship of αy=3+5β in order to satisfy mass conservation for the equation. Equation (1) indicates that if the reactant mixture of MₓO_{y}, Al, CaSi₂ and M is brought to the ignition temperature (T_{ig}), an exothermic chemical reaction (Combustion Synthesis) will be initiated. The reaction is of a self-propagating nature forming the products of ceramic slag (Al₂O₃, CaO, SiO₂) and liquid metals (M), which should be above their melting point, i.e be superheated liquid metals (SLMs) for metal joining applications. The combustion temperature reached in the process is T_{c}. At the same time, reactions between the slag phases will continue forming ternary compounds with an overall composition of Ca_{β}Al₂Si_{2β}O_{3+5β}.

The adiabatic temperature (T_{ad}), i.e. the maximum temperature that can be reached in a composition of the invention during reaction, and the composition of the reacted products are determined by the reaction stoichiometry (α, β, x, y in Equation 1) and the kinds of alloying metals being added to the reaction mixtures. The actual temperature reached, i.e. the combustion temperature (T_{c}) is usually lower than T_{ad} due to heat losses to the surrounding environment and to the articles being joined when a welding operation is being carried out. The choice of liquid metals (superheated liquid metals, SLMs) generated depends on the specific engineering application.

For example, if high electrical or thermal conductivity is required, then liquid copper should be chosen. For marine applications, Cu—Ni alloys may be used. For structural repair of steel structures, iron based alloys or steel-forming metals should be chosen. The SLMs can also be chosen so as to have the same or a similar composition to that of components being joined (welded) in order to reduce residual thermal stress.

In order to generate SLMs with desired engineering compositions, transition metals or other metals or alloys of transition metals and/or other metals may be present in the compositions of the invention as discussed above.

These metals or alloys will act as diluents thermodynamically to the reaction represented in Equation (1) and will increase the relative amount of SLMs produced but will tend to reduce the combustion temperature (T_{c}) achieved. There is a direct correlation between the relative amount of SLMs generated during the reaction and the combustion temperature achieved. The higher the SLMs content, the lower the combustion temperature for a given composition of metal or alloy produced. From practical point of view, lower slag (higher metals) content is preferred as long as the required combustion temperature is maintained.

It is preferable to have the combustion temperatures as high as practical to ensure a complete slag separation from the liquid metals since a higher temperature not only leads to higher diffusivity thus faster compositional homogenization and more uniform microstructures, less liquid metals are also needed to achieve the heat necessary for welding/joining. From this regard, it is preferable to have a combustion temperature exceeding the melting points of all alloying metals present in the mixture but without exceeding the boiling point(s) of the metal(s). Suitable compositions having the desired combustion temperature can be readily determined from calculation of the adiabatic temperature T_{ad} and simple experiments. The ratio of fuel (calcium silicide and aluminium) and oxidiser (transition metal oxide) to added metal can readily be adjusted to provide the desired combustion temperature.

As will be understood by those skilled in the art, the amount when expressed as a % by weight, of the fuel components employed (aluminium and calcium silicide), depends on the requirement to generate sufficient exothermic energy to produce the liquid metals from the mixture, release the slag from the metals and provide enough energy to fuse the liquid metals and the metallic components being joined. The % by weight figure also depends on the atomic masses of the transition metal in the oxide and any other metals employed. Use of metals with a higher atomic mass will result in compositions with a lower % by weight of fuel components in comparison with a composition of the same stoichiometry where the metals employed have a lower atomic mass.

The stoichiometry of the reaction mixture is adjusted so that the transition metal oxide or oxides employed provides sufficient oxygen for complete or near complete combustion of the fuel (conversion to the oxides).

Typical compositions of the invention have reaction mixtures containing more than 4% by weight of calcium silicide, more preferably more than 5% by weight of calcium silicide.

Preferred exothermic compositions of the invention include, but are not limited to the following compositions (expressed on a % by weight basis):

For producing copper and copper alloys, compositions comprising copper oxides, calcium silicide, aluminium and other metals selected from the group consisting of:

Copper (I) oxide (Cu₂O): 30-90%

### Calcium Silicide (CaSi₂): 1-11%

### Aluminium (Al): 0.5-9%;

Other metals: 0-60%;

### Copper (II) Oxide (CuO): 15-80%

### Calcium Silicide (CaSi₂): 2-18%

### Aluminium (Al): 1-11%;

Other metals: 0-70%; and

### Mixtures of Copper (I) Oxide and Copper (II) Oxide: 15-90%

### Calcium Silicide (CaSi₂): 1-18%

### Aluminium (Al): 0.5-11%;

Other metals: 0-70%.

For producing iron or iron alloys such as steels, compositions comprising iron oxides, calcium silicide, aluminium and other metals selected from the group consisting of:

### Iron (II) Oxide (FeO): 50-80%;

### Calcium Silicide (CaSi₂): 2-20%;

### Aluminium (Al): 1.0-20%;

Other metals: 0-50%;

### Iron (III) Oxide (Fe₂O₃): 35-80%;

### Calcium Silicide (CaSi₂): 2%-25%;

### Aluminium (Al): 1-20%;

Other metals: 0-50%;

### Iron (II,III) Oxide (Fe₃O₄): 40-80%;

### Calcium Silicide (CaSi₂): 2-25%;

### Aluminium (Al): 0.9-20%;

Other metals: 0-50%; and

For producing nickel and nickel alloys, compositions comprising nickel oxides, calcium silicide, aluminium and other metals selected from the group consisting of:

Nickel (II) oxide (NiO): 30-80%

### Calcium Silicide (CaSi₂): 1-20%

### Aluminium (Al): 0.5-16.0%;

Other metals: 0-60%;

Exothermic mixtures producing nickel metal or alloys of predominantly nickel constitute another aspect of the present invention. For these mixtures, the aluminium and calcium silicide system of the first aspect of the present invention is preferred.

Instead of using an oxide of only one element as shown in the compositions described above, a combination of oxides may also be used to form reactant mixtures that can form alloys upon reaction. For example, in order to produce certain Cu—Ni liquid alloys, in addition to the Al and CaSi₂ fuel, either CuO and Ni, or NiO and Cu, or CuO, NiO, Cu, and Ni can be used. In each case the desired oxygen content and combustion temperature T, is selected to ensure the temperature required for the desired use is achieved.

If the liquid alloy to be generated has a copper matrix (in the case copper is the main component of the liquid metal produced), then CuO and Ni are preferred. For a nickel matrix containing some copper a nickel oxide and copper metal system or a mixed oxide system is preferred. This mixture of oxides approach also extends to other alloys such as Cu—Fe and Fe—Ni, for example.

Another important factor in compositions used for exothermic welding or other applications where superheated liquid metals are required is the ignition temperature of the mixture. Ignition is achieved by an initial energy input from an external heat source. A mixture requiring a higher ignition energy indicates more difficult ignition as compared to a mixture with a lower value. Ignition energy is a thermodynamically and kinetically controlled parameter that is affected by the reaction stoichiometry, reactant particle size and morphology, packing density of the mixture, and heating rate. Normally ignition can only be achieved when the fuel is melted since molten fuel provides the faster mass diffusion transport necessary to initiate self-propagating chemical reactions. The compositions of the invention can produce mixtures which are readily ignited. Compositions of the invention can also have a relatively low adiabatic temperature (T_{ad}) whilst still having very good slag/metal separation characteristics. This allows lower temperature (safer) exothermic welding operations to be carried out whilst still providing good quality joints. Comparisons between compositions of the invention and prior art compositions are discussed hereafter with reference to specific embodiments.

Methods for making the exothermic compositions of the invention constitute a third aspect of the invention.

The exothermic compositions of the present invention can be made by simply mixing the various components together in a sufficiently intimate manner to allow ignition and propagation of the exothermic reaction. Preferably the components are mixed together by ball milling under an inert atmosphere.

The ball milled mixture may be used loosely packed or advantageously the ball milled mixture is compressed to give a “green” (i.e. unreacted) pellet of the desired density for use. Advantageously a pellet of 20-70% of the theoretical density of the mixture is prepared for use.

Preferably fine powders of the various components are used to ensure intimate mixing. Preferably powders of <45 μm mesh size are employed.

The purity of the various components of the mixture is less critical than with other welding methods as typical impurities will tend to evaporate away during reaction. However, preferably the components of a composition of the invention have a purity of >99% to provide high quality metals or alloys on reaction.

Methods of joining metallic components using the exothermic compositions constitute a fourth aspect of the present invention.

Thus according to a fourth aspect the present invention provides a method for joining metallic components comprising:

providing an exothermic reaction mixture for use in joining the metallic components comprising at least one transition metal oxide and, as fuel, a mixture of aluminium and calcium silicide, wherein the molar ratio of aluminium to calcium silicide is from 16:1 to 0.25:1;
igniting the exothermic reaction mixture to produce superheated liquid metals; and
allowing the superheated liquid metals to contact the metallic components thereby joining them together.

To join, for example, two metallic components together an exothermic composition of the invention, preferably a green pellet of a selected density is ignited to initiate the exothermic reaction. After ignition a self-propagating exothermic chemical reaction is initiated and the superheated liquid metal(s) (SLMs) and slag by-product are generated. Since the specific density of the slag is considerably lower than that of the SLMs, slag separates out and flows to the top of the SLMs. The SLMs are then used for welding, by allowing them to contact the metal components to be joined. For example the reaction mixture may be loaded into a suitable crucible and ignited. The slag floats on top of the superheated liquid metal (SLM) protecting it from the atmosphere. The SLMs may then be run out of the crucible, conveniently via a bottom outlet, and used for joining metal components.

Alternatively the exothermic mixture is ignited when in contact with the two metallic components being joined and welding occurs as the exothermic reaction proceeds. The exothermic mixture, preferably in the form of a green pellet, is typically used in sufficient quantity to produce sufficient SLM to fill the gap between the components being joined to produce a strong continuous weld.

The welding process may be carried out in the air in many cases, since the slag will flow to the top of the ignited mixture providing a protective layer. Alternatively and especially where best protection from the atmosphere is desired or required, the welding process may be carried out in an inert atmosphere such as argon or nitrogen.

The exothermic composition may be ignited by any suitable means. Preferred means when igniting in air include by use of gas torch such as an oxygen-propane torch, an oxygen-acetylene torch, or a Methylacetylene Propadiene Stabilised (MPS) gas torch. Other preferred means of ignition include the use of resistance heating wires. For example the use of a tungsten resistance heating wire in an inert atmosphere such as argon or nitrogen.

Where a crucible is employed in the methods of joining metallic components in the invention, it may be made of conventional refractory materials suitable for the application. For reactions that generate copper SLMs, the crucible may be made from graphite or engineering ceramics (e.g., Al₂O₃) if the combustion temperature is under 2000° C. For higher combustion temperatures, graphite is selected.

For reactions that generate iron (or steel) SLMs, graphite alone is not a good choice since it reacts with the molten iron thus contaminating the composition of the SLMs. Engineering ceramic such as Al₂O₃ is not suitable for those exothermic mixtures that generate a combustion temperature (T_{c}) above the melting point of Al₂O₃. Graphite can be employed if it is coated with other high temperature refractory materials such as boron nitride that are not as reactive with molten iron although this approach can introduce other contamination.

As an alternative, the methods of joining metallic components of the invention may employ a customized sacrificial crucible to prepare the superheated liquid metals from the exothermic mixtures of the invention.

Thus according to a fifth aspect the present invention provides a sacrificial crucible for use in a method of joining metallic components by means of a combustion synthesis reaction process; the sacrificial crucible being made from or having an inner lining made from metals or alloys that have the same or a compatible composition to that of the superheated liquid metals (SLMs) generated in the exothermic reaction of the combustion synthesis reaction process.

Preferably the method of joining metallic components is the method according to the fourth aspect of the present invention.

As with the methods when employing conventional crucibles, the SLMs are produced in a crucible by igniting an exothermic mixture of the invention and the slag separates out to provide a protective layer. Instead of using high temperature materials (e.g., graphite, Al₂O₃) to make the crucible, the sacrificial crucible is made from metals or alloys that have the same or a compatible composition to that of the SLM generated in the exothermic reaction. By compatible, it is meant that the metal or alloy employed is of a sufficiently similar composition to the SLMs being produced so as not to significantly alter its behaviour in the metal joining method or the structural integrity of a completed joint.

Alternatively the crucible may employ a sacrificial inner lining of metal or alloys of the same or a compatible composition to the SLMs. The inner lining is placed in an outer lining of a suitable refractory material (e.g. graphite or alumina), which provides additional strength and thermal insulation.

The sacrificial crucible may include heating elements, for example embedded in an insulating ceramic layer to allow inclusion of a pre-heating step in the method. The crucible and exothermic mixture can be pre-heated to an elevated temperature before ignition if required.

In use, the metals or alloys of the sacrificial crucible are partly melted into and become part of the SLMs. The SLM is not contaminated with undesirable components as the metal or alloy of the sacrificial crucible is selected to be the same or compatible with the desired SLM composition for the application. This is in contrast to methods using conventional crucibles where, depending on the temperatures reached, some contamination of the SLMs derived from the crucible material may be inevitable, leading to lower quality welds.

The sacrificial crucible also has the advantage of being low in cost and easily manufactured, for example by moulding and machining the metal or alloy body or lining as required. A sacrificial crucible can be used multiple times in the method depending on the thickness of the metal or alloy layer. When the layer (wall) thickness becomes too thin for continuing use the remaining metal or alloy can be recycled.

Advantageously the sacrificial crucible is provided with an outlet that comprises a seal of the metal or alloy employed for the crucible wall or inner lining. In use, the seal prevents the SLM from pouring out of the sacrificial crucible until a selected time (tₘ) after the reaction is initiated by ignition of the exothermic mixture. As the exothermic reaction develops and the SLMs are produced, the seal melts through allowing release of the SLM from the outlet. The seal is chosen to be thinner than that of the metal or alloy wall or inner lining.

The value of tₘ depends on the thickness of the seal, temperature and composition of the SLMs, the crucible and insulating materials employed. The value of tₘ can be estimated by thermal modelling. For example, to produce an SLM with a composition of 347 stainless steel and a combustion temperature of 2500° C., a 347 stainless steel may be chosen as the crucible material. The value of tₘ was found to be in the range of 1-15 s depending on the pre-heating temperature. Room temperature gave a tₘ of about 15 s and 800° C. pre-heating gave a tₘ of about is for a seal thickness of 3 mm.

### BRIEF DESCRIPTION OF THE DRAWINGS

FIG. 1 shows copper metal and associated slag following exothermic reaction of a composition of the invention;

FIG. 2 shows a carbon steel and associated slag following exothermic reaction of a composition of the invention;

FIG. 3 shows a nickel superalloy (Inconel 600) and associated slag following the combustion synthesis of a composition of the invention;

FIG. 4 is a flow chart illustration of a method of joining metal components of the invention;

FIG. 5 shows schematically a sacrificial crucible in use;

FIG. 6 is a flow chart illustration of another method of joining metal components of the invention;

FIG. 7 shows a copper bar welded to a steel bar;

FIG. 8 shows two copper bars welded together;

FIG. 9 shows two steel bars before and after welding together;

FIG. 10 shows two angled steel plates before (10a) and after (10b) welding together and also in cross section (10c); and

FIG. 11 shows the welded area from a joint made between two steel bars.

### DESCRIPTION SOME PREFERRED EMBODIMENTS AND EXPERIMENTAL RESULTS

In Table 1 below, the ignition and reaction characteristics (adiabatic temperature T_{ad} and slag/metal separation) of compositions of the invention are compared with some compositions according to the prior art. The compositions were made using copper, iron or nickel oxides together with aluminium and calcium silicide as the fuel. The adiabatic temperature of the mixtures was set for comparison purposes by adjusting the added metal content i.e. by adding copper or iron metal to the mixture as diluent.

The columns of the table list in order:
1. The liquid metal (copper, iron or nickel) produced on reaction of the mixture;
2. The composition of the products produced (metal and slag)−as % by weight;
3. The calculated adiabatic temperature of the mixture on reaction (T_{ad});
4. The ease of ignition of the mixture as determined by observation;
5. The slag/metal separation characteristics; and
6. The type of mixture (prior art or of the invention) employed in the experiment.

TABLE I
Reaction Characteristics of Selected Compositions

| | | 2 | | | | |
|---|---|---|---|---|---|---|
| | | Compositions^{†} | 3 | | 5 | 6 |
| | 1 | (Products), | T_{ad}, | 4 | Slag/Metal | Reaction |
| | SLMs | wt % | K | Ignition | Separation | Type |
| a | Cu | 85Cu—15A | 2722 | Good | Complete | Prior Art |
| b | Cu | 82.6Cu—17.4AN | 2722 | Good | Complete | Current |
| | | | | | | Invention |
| c | Cu | 87.5Cu—12.5A | 2356 | Not | / | Prior Art |
| | | | | Possible | | |
| d | Cu | 85.5Cu—14.5AN | 2356 | Good | Complete | Current |
| | | | | | | Invention |
| e | Fe | 60.3Fe—39.7A | 2860 | Good | Complete | Prior Art |
| f | Fe | 51.7Fe—48.3AN | 2860 | Good | Complete | Current |
| | | | | | | Invention |
| g | Fe | 73.4Fe—26.6A | 2300 | Good | No | Prior |
| | | | | | Separation | Art |
| h | Fe | 65.0Fe—35.0AN | 2300 | Good | Complete | Current |
| | | | | | | Invention |
| i | Fe | 78.9Fe—21.1A | 1823 | Not | / | Prior Art |
| | | | | Possible | | |
| j | Fe | 72.4Fe—27.6AN | 1823 | Good | Complete | Current |
| | | | | | | Invention |
| k | Ni | 79.1Ni—20.9A | 2332 | Dif- | Partial | Prior Art |
| | | | | ficult | | |
| l | Ni | 74.8Ni—25.2AN | 2332 | Good | Complete | Current |
| | | | | | | Invention |

^{†}A—Al2O3, AN—Anorthite (CaAl₂Si₂O₈).

It can be seen that the mixtures of the invention extend the ignition range to compositions with a much lower adiabatic temperature T_{ad} (and hence combustion temperature T_{c}) than the prior art compositions.

Considering the copper producing examples (a to d) it can be seen that ignition could not be achieved for the mixtures with a T_{ad} of 2356K using the prior art type (i.e., only aluminium used as the fuel) compositions, while a successful ignition was not only achieved for the copper mixture with a T_{ad} value of 2356K in the current invention, but a complete slag and metal separation was also achieved.

Similarly for the iron examples (e to j), a reactant mixture having a T_{ad} value of 2300K from the prior art type (i.e., only aluminium used as the fuel) composition could not achieve a complete slag and metal separation. However, the reactant mixture with a T_{ad} value of 1823K in the current invention not only achieved ignition and reaction, but a complete slag and metal separation was also achieved.

For nickel examples (k,l), a reactant mixture having a T_{ad} value of 2332K from the prior art (i.e., only aluminium used as the fuel) composition was a difficult to ignite and the slag was not separated completely from the liquid nickel metal. However, a mixture with the same T_{ad} value of the current invention (producing an anorthite slag) was not only easily ignited, but a complete slag and metal separation was also achieved.

These experiments show that compositions using only aluminium as fuel are more difficult to ignite, especially for those mixtures that contain a significant amount of metal diluents. A mixture that is difficult to ignite often leads to extensive preheating to the mixture and violent reaction, which can be a safety hazard. In many welding applications, it is desirable to use an exothermic mixture that requires only a low ignition energy and easy ignition. Although the mechanism of the easy ignition of the mixtures of the invention is not clear, it is possible that this it is assisted by the formation of the thermodynamically more stable calcium oxide due on decomposition of the calcium di-silicide.

Another advantage of the current invention, illustrated by the results in Table 1, is that the exothermic mixtures are not only easier to ignite but useable mixtures (successful liquid metal generation with good slag separation) can be made with a lower adiabatic temperature T_{ad}. This allows welding to be carried out at lower temperatures if desired.

Still another advantage of the current invention has to do with the fact that the improved slag/metal separation characteristics which can lead to the generation of higher quality (purer and less slag inclusions) SLMs. This is believed to be largely due to the fact that the slag generated is based on the CaO—Al₂O₃—SiO₂ system and have lower densities and lower melting points than that of Al₂O₃ as generated in prior art compositions. According to the Stoke's law, the rate of the slag separation from SLMs during the combustion synthesis reaction is proportional to δρ/μ where δρ is the density difference between the slag and liquid metals, and μ is the dynamic viscosity of the liquid metals. If one assumes that reactions having the same adiabatic temperature would have the same combustion temperature (ignoring heat loss), then the SLMs generated during the reaction would have the same dynamic viscosity. Thus, the better slag and metal separation as observed in the current invention (shown in Table 1) was mainly caused by the larger δρ value (less dense slag) giving a high separation rate. In addition, since the preferred embodiments generate slag having much lower melting points, this will increase the flowability of the slag hence promoting the slag separation. These reasons for good separation characteristics would be expected to be maintained for more exothermic reactant mixtures of the invention. The compositions of the invention can therefore produce higher quality SLMs (purer, with less slag inclusions) than prior art compositions.

The following examples, using copper (Cu), nickel (Ni), and iron (Fe) containing compositions demonstrate the utility of the mixtures of the invention. Other liquid metals may also be formed and used from compositions of the invention, which include other metal oxides and or metals.

Superheated liquid copper or its alloys may be used to weld or join various copper alloys, or in joining other metals. Copper or copper alloys are preferred where minimum electrical resistance is required at the joint. Generation of superheated liquid Cu metals can be achieved with compositions of the invention, by choosing MₓO_{y} either as CuO or Cu₂O (in equation 1). Reactions using CuO are more exothermic than Cu₂O for generating the same amount of liquid Cu in the overall reactant mixture. Generally speaking, the higher the combustion temperature, the better slag and metals separation. In the compositions of the invention, it was found that a complete slag separation could be achieved when the T_{ad} was equal to or higher than 2356K (table 1 above). It is also preferable to have the T_{ad} below the boiling point of copper (2846K) since higher temperatures will generate too much copper vapour during the reaction, which poses some safety and practicality concerns, if the reaction is conducted in the open atmosphere. If necessary, where the reaction mixture is near a boiling point of a component, reaction can be conducted inside a sealed and pressurized chamber.

### Example 1

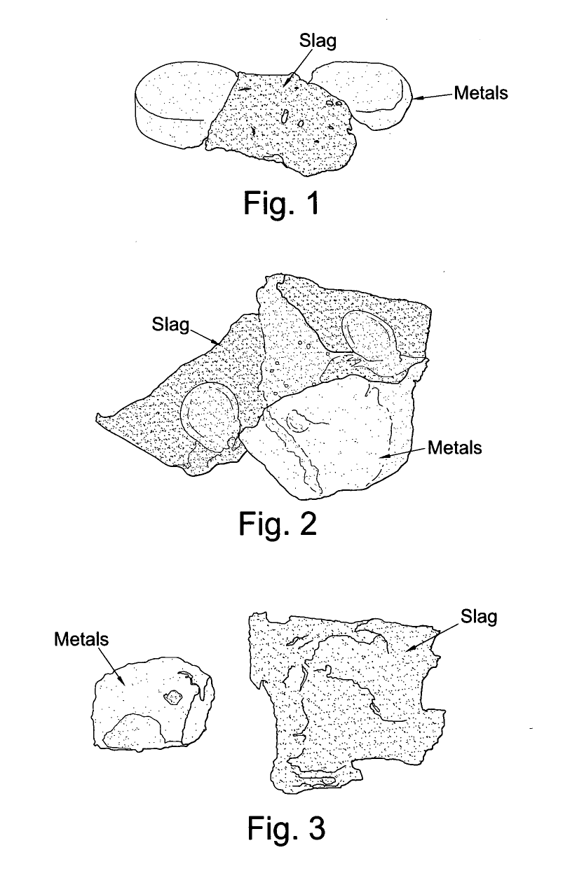

Superheated liquid Cu can be generated by the following reaction mixture (mass): 40.1% CuO, 3.4% Al, 50.4% Cu, and 6.1% CaSi₂. The molar ratio of to aluminium to calcium silicide in this mixture is 2:1. Upon thoroughly mixing of the reactant powders, about 5 g of the mixture was uniaxially pressed into a cylindrical pellet with a relative density of 57% (in comparison with the theoretical density of the mixture). then ignited in air using an oxygen-propane torch. This combustion synthesis reaction had an adiabatic temperature of 2737K. The slag generated had a composition of CaAl₂Si₂O₈ (anorthite). After reaction, the slag was totally separated out from the Cu metal, as shown in FIG. 1. It was also found that the slag was amorphous as shown in FIG. 1 and confirmed by the X-ray Diffraction (XRD). Reaction mixtures with similar compositions and different combustion temperatures can be readily formulated by those familiar to the Combustion Synthesis technique.

### Example 2

Cu—Ni alloys (e.g., Cu-10Ni and Cu-30Ni) are widely used in marine and other corrosive environments. Superheated Cu—Ni liquid alloys generated by the current invention can be used to join or repair this kind of structures. The following reaction mixture (mass %) can generate superheated Cu-30Ni liquid: 44.7% CuO, 3.8% Al, 20.7% Cu, 24.1% Ni, and 6.8% CaSi₂. The molar ratio of aluminium to calcium silicide in this mixture is 2:1. Upon thoroughly mixing of the reactant powders, about 20 g of the mixture was loosely packed into a cylindrical graphite mould, then ignited in air using a MPS torch. This combustion synthesis reaction had an adiabatic temperature of 2810K. The slag generated had a composition of CaAl₂Si₂O₈ (anorthite). After reaction, slag was totally separated out from the Cu—Ni alloy, similar to the morphology shown in FIG. 1 and it was also found that the slag was in amorphous state. Reaction mixtures with similar compositions and different combustion temperatures can be readily formulated by those familiar to the Combustion Synthesis technique.

### Example 3

The Cu—Ni—Sn spinodal alloys (e.g., Cu-15Ni-8Sn and Cu-9Ni-6Sn) are robust materials for bearings. Superheated spinodal liquid alloys generated by the current invention can be used to join or repair this kind of structures. The following reaction mixture (mass %) can generate superheated Cu-15Ni-8Sn liquid: 40% CuO, 3.4% Al, 31.5% Cu, 12.4% Ni, 6.6% Sn, and 6.1% CaSi₂. The molar ratio of to aluminium to calcium silicide in this mixture is 2:1. After thoroughly mixing of the reactant powders, about 5 g was uniaxially pressed into a cylindrical pellet with a relative density of 57%, then ignited in air using an oxygen-propane torch. This combustion synthesis reaction had an adiabatic temperature of 2725K. The slag generated had a composition of CaAl₂Si₂O₈ (anorthite). After reaction, slag was totally separated out from the Cu—Ni—Sn alloy, similar to the morphology shown in FIG. 1 and it was also found that the slag was in amorphous and confirmed by the X-ray Diffraction (XRD). Reaction mixtures with similar compositions and different combustion temperatures can be readily formulated by those familiar to the Combustion Synthesis technique.

### Example 4

Superheated Cu-9Ni-6Sn spinodal liquid alloys can be generated using the following reaction mixture (mass %): 39.1% CuO, 4.8% Al, 39.3% Cu, 7.5% Ni, 5.0% Sn, and 4.3% CaSi₂. The molar ratio of to aluminium to calcium silicide in this mixture is 4:1. Upon thoroughly mixing of the reactant powders, about 5 g of the mixture was uniaxially pressed into a cylindrical pellet with a relative density of 57%, then ignited in air using a MPS torch. This combustion synthesis reaction had an adiabatic temperature of 2767K. The slag generated had a composition of CaAl₄Si₂O₁₁ After reaction, slag was totally separated out from the Cu—Ni—Sn alloy, similar to the morphology shown in FIG. 1. Reaction mixtures with similar compositions and different combustion temperatures can be readily formulated by those familiar to the Combustion Synthesis technique.

### Example 5

Copper (I) oxide, Cu₂O can be used to substitute full or part of copper (II) oxide in all of the previous examples to generate exactly the same superheated liquid Cu compositions. Reaction mixtures generating exactly the same superheated spinodal liquid (Cu-15Ni-9Sn) and slag composition (anorthite) can be generated using the following reaction mixture (mass %): 71.6% Cu₂O, 3.4% Al, 12.4% Ni, 6.6% Sn, and 6.0% CaSi₂. The molar ratio of to aluminium to calcium silicide in this mixture is 2:1. After thoroughly mixing the reactant powders, about 5 g was uniaxially pressed into a cylindrical pellet with a relative density of 57%, and then ignited in air using a MPS torch. This combustion synthesis reaction has an adiabatic temperature of 2601K, lower than that in example 3. After reaction, slag was totally separated out from the Cu—Ni—Sn alloy, similar to the morphology shown in FIG. 1. Although this example demonstrates fully substitution of CuO by Cu₂O, it is understood that partial substitution can also achieve the same goal. Other reaction mixtures having similar compositions and different combustion temperatures, as well as welding/joining demonstrated later in this article can be readily formulated by using Cu₂O as a substitute to CuO in full or in part, by those familiar to the Combustion Synthesis technique.

Superheated liquid iron and its alloys may be used to join/weld or repair ferrous or other alloy or structures. Generation of superheated liquid iron metals can be achieved by choosing MₓO_{y} (Equation 1) either as Fe₂O₃ or Fe₃O₄ in compositions of the invention. Generally speaking, reaction using Fe₂O₃ was more exothermic than Fe₃O₄ when generating the same amount of liquid Fe. Various metals can be added to the mixture to generate the liquid iron alloys for specific applications. It was found that easy ignition and completely separation of slag from liquid iron could be achieved for the mixtures with an adiabatic temperature (T_{ad}) of 1823K in the current invention, while it is well known that in the prior art compositions, i.e., the Thermit® type (i.e., only aluminium used as the fuel), a complete slag and metal separation can not be achieved if the adiabatic temperature of the reaction is below 2327K, the melting point of Al₂O₃ (see B. Shwartz, “Thermite Welding”, ASM Handbook, vol. 6, “Welding, Brazing, and Soldering”, ASM International, 2007). This conclusion was also verified in the current work as shown in Table I. It was found that using a Thermit® type mixture (aluminium only as fuel), a complete slag and liquid Fe separation could only be achieved for mixtures with a T_{ad} higher than approximately 2500K.

### Example 6

Carbon steels are widely used in all kinds of engineering applications. Superheated carbon steel liquid may be used to join or repair these types of structures. The following reaction mixture (mass %) can generate SLMs with a composition similar to the AISI 4140: 71.3% Fe₂O₃, 9.1% Al, 0.1% Mo, 0.8Mn, 0.5Cr, 1.9% Si, 0.2% C and 16.1% CaSi₂. The molar ratio of aluminium to calcium silicide in this mixture is 2:1. Upon thoroughly mixing of the reactant powders, about log was loosely packed into a cylindrical graphite crucible with a graphite felt liner which was coated with a layer of boron nitride spray, then ignited in air using a MPS torch. This combustion synthesis reaction had an adiabatic temperature of 2749K. The slag generated had a composition of CaAl₂Si₂O₈ (anorthite). After reaction, the slag was totally separated out from the alloy, as shown in FIG. 2. Reaction mixtures with similar compositions (e.g., other carbon steels) and different combustion temperatures can be readily formulated by those familiar to the Combustion Synthesis technique.

### Example 7

Stainless steels are widely used in corrosive environments in various industries. Superheated stainless steel liquid may be used to join or repair these types of structures. The following reaction mixture (mass %) can generate SLMs with a composition similar to the AISI 347 stainless steel: 59.23% Fe₂O₃, 15.01% Al, 6.80% Ni, 11.13% Cr, 1.24% Mn, 0.62% Si, 0.62% Nb, and 5.35% CaSi₂. The molar ratio of to aluminium to calcium silicide in this mixture is 10:1. Upon thoroughly mixing of the reactant powders, the mixture of about 5 g was pressed into a green pellet of approximately 55% density, then was ignited in air using a MPS torch. This combustion synthesis reaction had an adiabatic temperature of 2675K. The slag generated had a composition of CaAl₁₀Si₂O₂₀. After reaction, the slag was totally separated out from the alloy, similar to the morphology shown in FIG. 2. Reaction mixtures with similar compositions (e.g., other stainless or high alloy steels) and different combustion temperatures can be readily formulated by those familiar with the Combustion Synthesis technique.

### Example 8

The iron (III) oxide, Fe₂O₃ used in the previous examples may also be totally or partially substituted by iron (II) oxide, FeO or iron (II,III) oxide, Fe₃O₄ to generate exactly the same superheated liquid iron compositions. The following reaction mixture (mass %) can generate the same superheated AISI 4140 steel as shown in the Example 6: 73.03% Fe₃O₄, 14.59% Al, 0.85% Mn, 0.11% Mo, 0.54% Cr, 1.98% Si, 0.23% C and 8.67% CaSi₂. The molar ratio of to aluminium to calcium silicide in this mixture is 6:1. After thoroughly mixing of the reactant powders, about 5 g of the mixture was pressed into a green pellet of approximately 55% density, and then ignited in air using a MPS torch. This combustion synthesis reaction had an adiabatic temperature of 2735K. The slag generated had a composition of CaAl₆Si₂O₁₄. After reaction, the slag was totally separated out from the liquid alloy, similar to the morphology shown in FIG. 2. Although this example demonstrates full substitution of Fe₂O₃ by Fe₃O₄, it is understood that partial substitution can also achieve the same goal. Other reaction mixtures having similar compositions and different combustion temperatures can be readily formulated by using Fe₃O₄ as a substitute to Fe₂O₃ in full or in part, by those familiar to the Combustion Synthesis technique.

Superheated liquid nickel and its alloys may be used to join/weld or repair nickel or other alloys (e.g., nickel superalloys) or structures. Generation of superheated liquid nickel metals can be achieved by choosing MₓO_{y} as NiO (Equation 1) in compositions of the invention. Various metals can be added to the mixture to generate the desired liquid nickel alloys for specific applications.

### Example 9

Nickel superalloys are widely used in high temperature applications such as aerospace turbine blades. Superheated Ni superalloys liquid may be used to join or repair these types of structures. The following reaction mixture (mass %) can generate superheated Inconel 600 metal liquid: 60.31% NiO, 5.45% Al, 9.72% CaSi₂, 7.11% Ni, 11.12% Cr, 0.36% Mn, 0.14% Si, 5.73% Fe, and 0.06% C. The molar ratio of to aluminium to calcium silicide in this mixture is 2:1.

Upon thoroughly mixing of the reactant powders, a mixture of about 5 g was pressed into a green pellet of approximately 55% density, then was ignited in air using a MPS torch. This combustion synthesis reaction had an adiabatic temperature of 2450K. The slag generated had a composition of CaAl₂Si₂O₈ (anorthite). After reaction, the slag was totally separated out from the alloy as shown in FIG. 3. Reaction mixtures with similar compositions (e.g., other nickel superalloy compositions) and different combustion temperatures can be readily formulated by those familiar with the Combustion Synthesis technique.

Welding or joining of various metal structures using the compositions of the invention can be achieved by either directly placing the reaction mixtures between the structures to be joined or using a separate crucible for the reaction and slag/metals separation, followed by directing the superheated liquid metals between the structures to be joined.

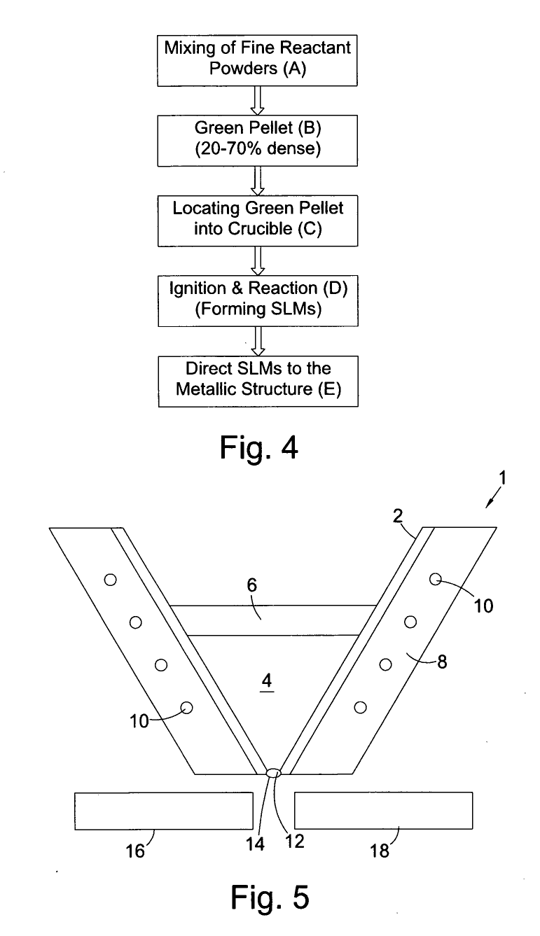

FIG. 4 is a flow chart illustrating an example of the method where a crucible is used. The reactants, as fine powders, are mixed (step A), preferably in a ball mill to ensure intimate mixing. A green pellet is then formed by compression of the mixture (B) to a density of 20-70% of the theoretical. The green pellet is placed in a suitable crucible (C) and the mixture then ignited to initiate reaction (D). The superheated liquid metal (SLM) produced is then directed from the crucible to the metal structures to be joined. Preheating of the metallic structures was found to be helpful, especially when the amount of the exothermic mixture employed was relatively low. When preheating was carried out in air, a conventional welding flux can be used to protect the structures from oxidation.

A sacrificial crucible 1 that can be used in the method of FIG. 4 is illustrated in FIG. 5.

The sacrificial crucible 1 has a crucible wall 2 of the same composition as the superheated liquid metals (SLMs) 4 which have been formed in the crucible 1 as a result of ignition of an exothermic mixture of the invention. The SLMs 4 are protected by the slag layer 6 floating on top.

The crucible 1 includes an outer layer of insulating ceramics 8 which supports the crucible wall 2 and includes electric heating elements 10 for pre-heating the crucible (if desired) before the exothermic reaction is initiated.

A seal 12 of the same composition as the crucible wall 2 prevents the SLMs 4 from exiting the bottom outlet 14 of the crucible 1 until after the seal has melted due to the heat from the SLMs. After the seal 12 melts the SLMs flow out of the bottom outlet 14 and between the two metal components 16,18 placed beneath the crucible 1 and weld them together. While the crucible 1 is filled with SLMs 4 the wall 2 also melts slightly. The melting of the seal 12 and wall 2 does not interfere with the quality of the SLMs and the joint made using them because they have the same composition.

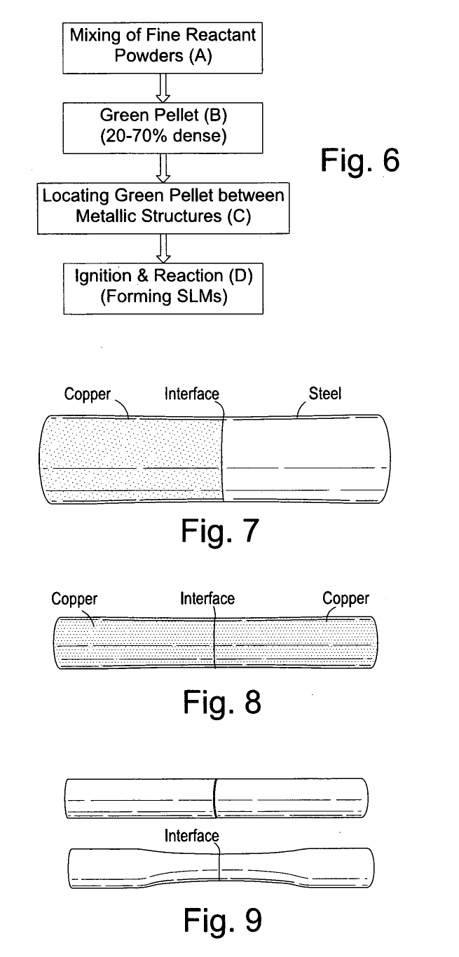

An alternative example of the joining method is shown in the flow chart of FIG. 6. Preparation of the green pellet is carried out in the same way (steps A, B) but the green pellet is then placed between the metallic structures to be joined (C), rather than in a crucible. The mixture is then ignited and the SLMs generated forms a welded joint (D).

Using the joining methods shown in FIGS. 4-6, successful welding has been achieved between steels, coppers, and steel to copper structures having various cross sections which include cylinder, pipe, and wedge shaped steels.

### Example 10

The reaction mixture described in Example 1 was used to weld a steel (A356) bar to a copper bar. The bars had a cylindrical cross section with a diameter of 12.7 mm and a length of 38.1 mm. The join ends were cleaned using a sand paper, applied a layer of welding flux and preheated at approximately 450 C for a few minutes. The thoroughly mixed reactants were loosely loaded into a graphite crucible, and then ignited using an oxygen-propane torch. During the reaction, the slag floated to the top and was separated out from the liquid metals. In addition, the slag protected the metals underneath from oxidation. Shortly after the reaction, the liquid metals were directed to the gap between the two bars. The high quality interface is shown in FIG. 7 (polished) which also clearly shows the melting (fusing) of the steel (and the copper) at the interface. Welding could also be achieved by using reaction mixtures shown in other examples, or those having similar compositions and different combustion temperatures that can be readily formulated by those familiar to the Combustion Synthesis technique.

### Example 11

The reaction mixture shown in Example 3 was used to weld two copper bars. The bars had a cylindrical cross section with a diameter of 12.7 mm and a length of 38.1 mm. The join ends were cleaned using a sand paper, a layer of welding flux applied and they were then preheated at approximately 450° C. for a few minutes. The thoroughly mixed reactants were loaded into a graphite crucible, and then ignited using an oxygen-propane torch. During the reaction, the slag floated to the top and was separated out from the metals. In addition, the slag protected the metals underneath from oxidation. Shortly after the reaction, the liquid metals were directed to the gap between the two bars. The high quality interface is shown in FIG. 8 (polished) which also clearly shows the melting of the copper at the interface. Welding could also be achieved by using reaction mixtures shown in other examples, or those having similar compositions and different combustion temperatures that can be readily formulated by those familiar to the Combustion Synthesis technique.

### Example 12

The reaction mixture shown in Example 3 was used to weld two steel (A356) bars. The bars had a cylindrical cross section with a diameter of 12.7 mm and a length of 38.1 mm. The join ends were cleaned using a sand paper, a layer of welding flux was applied and they were then preheated at approximately 450° C. for a few minutes. The thoroughly mixed reactants were loaded into a graphite crucible. The reaction mixture was then ignited using an oxygen-propane torch. During the reaction, the slag floated to the top and was separated out from the metals. In addition, the slag protected the metals underneath from oxidation. Shortly after the reaction, the liquid alloy (Cu-15Ni-8Sn) was directed to the gap between the two bars. The two bars before and after welding are shown in FIG. 9. The majority of the liquid alloy was squeezed out of the joint area. The high quality interface is shown in FIG. 9 (bottom) after polishing. Welding could also be achieved by using reaction mixtures shown in other examples, or those having similar compositions and different combustion temperatures that can be readily formulated by those familiar to the Combustion Synthesis technique.

### Example 13

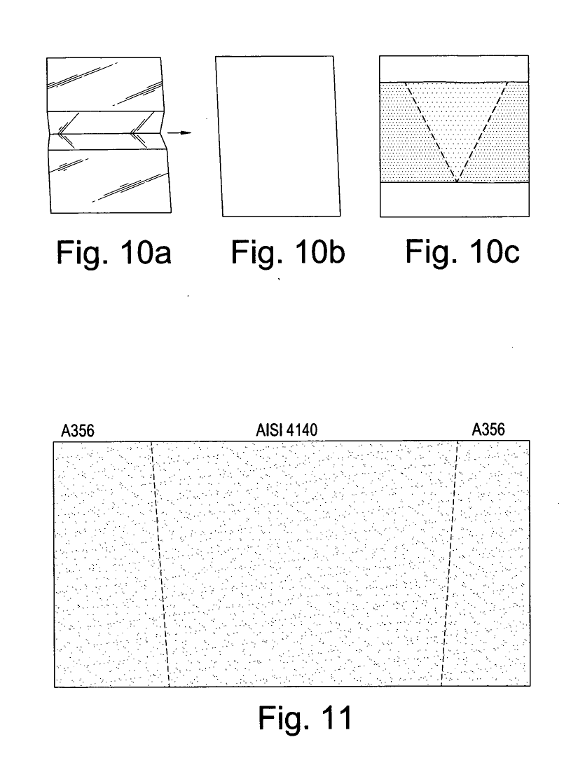

The reaction mixture shown in Example 3 was used to weld two angled steel (A356) plates, without use of a crucible (method of FIG. 6). The plates had a dimension of 63.5 mm by 50.8 mm by 12.7 mm and were machined into wedge shapes as shown in FIG. 10a. The join grooves were cleaned using a sand paper, a layer of welding flux was applied and they were then preheated at approximately 450° C. for a few minutes. The thoroughly mixed reactant mixtures were directly loaded into the grooves, and ignited using an oxygen-propane torch. During the reaction, the slag floated to the top and was separated out from the metals. In addition, the slag protected the metals underneath from oxidation. The high quality interface is shown in the cross section FIG. 10c (polished). Welding could also be achieved by using reaction mixtures shown in other examples, or those having similar compositions and different combustion temperatures that can be readily formulated by those familiar to the Combustion Synthesis technique.

### Example 14

The reaction mixture shown in Example 6 was used to weld two steel (A356) bars. The bars had a cylindrical cross section with a diameter of 12.7 mm and a length of 38.1 mm. The join ends were cleaned using a sand paper, a layer of welding flux was applied and they were then preheated at approximately 450° C. for a few minutes. The thoroughly mixed reactant mixtures were loaded into a graphite crucible which was coated with boron nitride, The reaction mixture was then ignited using an oxygen-propane torch. During the reaction, the slag floated to the top and was separated out from the liquid alloy. In addition, the slag protected the metals underneath from oxidation. Shortly after the reaction, the liquid alloy was directed to the gap between the two bars. The high quality interface resulting is shown in FIG. 11 (polished). Welding could also be achieved by using reaction mixtures shown in other examples, or those having similar compositions and different combustion temperatures that can be readily formulated by those familiar to the Combustion Synthesis technique.

It will be appreciated that the above examples illustrate only some of the possible wide range of compositions of the invention and their possible uses. A wide range of metals and alloys can be joined by selection of an appropriate exothermic mixture of the invention having a suitable reaction temperature and metal composition. Suitable mixtures can be readily formulated by those familiar with the combustion synthesis technique.

1. An exothermic reaction mixture for use in joining metallic components comprising:
at least one transition metal oxide; and,
a mixture of aluminium and calcium silicide, wherein the molar ratio of aluminium to calcium silicide is from 16:1 to 0.25:1.

2. An exothermic reaction mixture as claimed in claim 1 wherein the molar ratio of aluminium to calcium silicide in the mixture is from 10:1 to 0.4:1.

3. An exothermic reaction mixture as claimed in claim 1 wherein the molar ratio of aluminium to calcium silicide in the mixture is 2:1, thereby generating a slag having the composition of the mineral anorthite (CaAl₂Si₂O₈) on combustion.

4. An exothermic reaction mixture as claimed in claim 1 wherein the molar ratio of aluminium:calcium silicide is 10:1 thereby producing a slag composition corresponding to a 4:1 molar mixture of alumina (Al₂O₃):anorthite (CaAl₂Si₂O₈).

5. An exothermic reaction mixture as claimed in claim 1 wherein the mixture produces a slag with components in the ranges:
Calcium Oxide (CaO): 5.6-29.7%
Silica (SiO₂): 12.1-63.6%
Alumina (Al₂O₃): 6.7-82.3%, by weight.

6. An exothermic reaction mixture as claimed in claim 1 wherein the at least one transition metal oxide is selected from the group consisting of: oxides of copper (Cu); iron (Fe); tin (Sn); nickel (Ni); chromium (Cr); cobalt (Co); vanadium (V); and molybdenum (Mo).

7. An exothermic reaction mixture as claimed in claim 1 further comprising additional components selected from the group consisting of: transition metals; other metals; alloys of transition metals; alloys of other metals; and alloys of transition metals with other metals.

8. An exothermic reaction mixture as claimed in claim 7 wherein the said exothermic reaction mixture comprises at least one transition metal selected from the group consisting of: copper (Cu); iron (Fe); tin (Sn); nickel (Ni); chromium (Cr); cobalt (Co); vanadium (V); manganese (Mn); and molybdenum (Mo).

9. An exothermic reaction mixture as claimed in claim 1 wherein the combustion temperature of the mixture exceeds the melting points of all alloying metals present in the mixture and does not exceed the boiling points of the said alloying metals.

10. An exothermic reaction mixture as claimed in claim 1 wherein more than 4% by weight of calcium silicide is present.

11. An exothermic reaction mixture as claimed in claim 1 having a composition, on a % by weight basis, selected from the group consisting of:
a) Copper (I) oxide (Cu₂O): 30-90%
Calcium Silicide (CaSi₂): 1-11%
Aluminium (Al): 0.5-9%
Other metals: 0-60%;
b) Copper (II) Oxide (CuO): 15-80%
Calcium Silicide (CaSi₂): 2-18%
Aluminium (Al): 1-11%
Other metals: 0-70%; and
c) Mixtures of Copper (I) Oxide and Copper (II) Oxide: 15-90%
Calcium Silicide (CaSi₂): 1-18%
Aluminium (Al): 0.5-11%
Other metals: 0-70%.

12. An exothermic reaction mixture as claimed in claim 1 having a composition, on a % by weight basis, selected from the group consisting of:
a) Iron (II) Oxide (FeO): 50-80%
Calcium Silicide (CaSi₂): 2-20%
Aluminium (Al): 1.0-20%
Other metals: 0-50%;
b) Iron (III) Oxide (Fe₂O₃): 35-80%
Calcium Silicide (CaSi₂): 2%-25%
Aluminium (Al): 1-20%
Other metals: 0-50%; and
c) Iron (II,III) Oxide (Fe₃O₄): 40-80%;
Calcium Silicide (CaSi₂): 2-25%;
Aluminium (Al): 0.9-20%;
Other metals: 0-50%.

13. An exothermic reaction mixture as claimed in claim 1 having a composition, on a % by weight basis, of:
Nickel (II) oxide (NiO): 30-80%
Calcium Silicide (CaSi₂): 1-20%
Aluminium (Al): 0.5-16.0%
Other metals: 0-60%.

14. A method of preparing an exothermic reaction mixture having a composition according to claim 1 the method comprising:
intimately mixing the components of the mixture.

15. The method as claimed in claim 14 wherein the components are mixed together by ball milling under an inert atmosphere.

16. The method as claimed in claim 15 wherein the ball milled mixture is compressed to produce a pellet of a selected density.

17. The method as claimed in claim 16 wherein a pellet of from 20% to 70% of the theoretical density is produced.

18. The method as claimed in claim 14 wherein the components are in the form of powders of <45 μm mesh size.

19. The method as claimed claim 14 wherein the components have a purity of >99%.

20. A method for joining metallic components comprising:
providing an exothermic reaction mixture according to claim 1;
igniting the exothermic reaction mixture to produce superheated liquid metals; and
allowing the superheated liquid metals to contact the said metallic components, thereby joining them together.

21. The method as claimed in claim 20 wherein the exothermic reaction mixture is provided in the form of a pellet of a selected density.

22. The method as claimed in claim 20 wherein the reaction mixture is ignited in a crucible and the superheated liquid metals produced are run out of the crucible for use in joining the metallic components.

23. The method as claimed in claim 22 wherein the crucible employed is a sacrificial crucible; the sacrificial crucible comprising or having an inner lining comprising metals or alloys that have the same or a compatible composition to that of the superheated liquid metals generated in the exothermic reaction.

24. The method as claimed in claim 20 wherein the exothermic mixture is ignited when in contact with the two metallic components being joined and welding occurs as the exothermic reaction proceeds.

25. A sacrificial crucible for use in a method of joining metallic components by means of a combustion synthesis reaction process; the sacrificial crucible comprising or having an inner lining comprising metals or alloys that have the same or a compatible composition to that of the superheated liquid metals generated in the exothermic reaction of the combustion synthesis reaction process.

26. The sacrificial crucible as claimed in claim 25 having an inner lining comprising metals or alloys and an outer lining of a refractory material.

27. The sacrificial crucible as claimed in claim 25 further comprising heating elements.

28. The sacrificial crucible as claimed in claim 25 further comprising an outlet that comprises a seal of the metal or alloy employed for the crucible wall or inner lining, the seal preventing the superheated liquid metals from pouring out of the sacrificial crucible until a selected time (tₘ) after the reaction is initiated by ignition of the exothermic mixture.
